(19) United States
(12) Patent Application Publication
(10) Pub. No.: US 2004/0173588 A1
(43) Pub. Date: Sep. 9, 2004

(54) Method for joining an electrode to a precious-metal section

(76) Inventors: Andreas Benz, Bamberg (DE); Ulrich Haag, Pluederhausen (DE)

Correspondence Address: KENYON & KENYON, ONE BROADWAY, NEW YORK, NY, 10004, US

(21) Appl. No.: 10/722,655

(22) Filed: Nov. 25, 2003

(30) Foreign Application Priority Data
Nov. 27, 2002 (DE) 102 55 187.1

(51) Int. Cl. H01T 1/22; H01T 21/02; B23K 26/22

(52) U.S. Cl. 219/121.64; 313/141; 445/7

(57) ABSTRACT

A method for joining a precious-metal section to an electrode of a spark plug is provide, the precious-metal section being joined to the electrode by means of heat input generated by a laser beam. The laser beam is applied to the precious-metal section and optionally also to the electrode. During the heat introduction, the laser beam covers substantially the entire surface of the precious-metal section. No relative movement occurs between the laser beam and the precious-metal section during the heat introduction.

### FIELD OF THE INVENTION

The present invention relates to a method for joining an electrode of a spark plug to a precious-metal section.

### BACKGROUND OF THE INVENTION

A method for joining an electrode of a spark plug to a precious-metal section is described in published German patent document DE 101 03 045, for example. According to DE 101 03 045, a center electrode is joined to a precious metal by the precious metal being deposited on the center electrode in the form of a wire and a laser beam, having a pointed focus, being aimed at a section of the precious metal, so that the precious metal melts due to the received heat and is joined to the center electrode. By rotating the center electrode, and thus the precious-metal wire, counter to the laser beam, the precious-metal wire is covered by the laser beam across its full length and joined to the center electrode. The precious metal has better corrosion and erosion resistance than the material of the center electrode.

Published German patent document DE 37 27 526 discloses a similar method, in which the center electrode is rotated counter to a pulsed laser beam that is oriented in the longitudinal direction of the center electrode.

Furthermore, a known method in the art involves applying a precious-metal wire to a ground electrode by laser welding, in which method the ground electrode undergoes a translational motion with respect to the laser beam.

The above-mentioned methods present a disadvantage in that the relative movement of the electrode and the precious-metal section counter to the laser beam is costly from the standpoint of production engineering. Furthermore, in the above-mentioned methods the welding seam protrudes or caves in, which is an undesired characteristic.

In addition to the above, published German patent document DE 31 32 814 discloses applying a precious-metal wafer onto an electrode by resistance welding. However, this technology is able to produce only a small diffusion zone between the electrode material and precious metal, thereby limiting the durability of the joint.

### SUMMARY OF THE INVENTION

The method according to the present invention provides a simple and cost-effective manner of joining an electrode of a spark plug to a precious-metal section since, in contrast to the known art, the mechanism for achieving the relative movement between the laser beam and the electrode may be omitted, and since a cost-effective laser, e.g., a diode laser, may be employed.

Furthermore, the method according to the present invention produces a particularly even joint between the electrode and precious-metal section, i.e., the precious-metal section forms a flat surface without pronounced protrusions or recesses.

In accordance with the present invention, a reliable joint between the electrode and precious-metal segment is ensured by fusing the precious-metal section and the electrode by means of the heat input of the laser beam in the region of the precious metal. In the process, the material of the precious-metal section and the material of the electrode mix to form an alloy. However, compared to the pure material of the precious-metal section, this alloy has poorer corrosion and erosion resistance.

In accordance with the present invention, the laser beam is designed in such a way that, using appropriate beam guidance and beam shaping, the intensity of the laser beam varies, i.e., the laser beam impinging upon a first region of the precious-metal section has a higher intensity than the laser beam impinging upon a second region of the precious-metal section. This causes the precious-metal section to melt completely in the first region (with higher beam intensity) and to form an alloy with the material of the electrode, thereby ensuring a reliable joint between the precious-metal section and the electrode. In the second region (with lesser beam intensity), the precious metal does not melt completely, so that the proportion of the electrode material is markedly lower in the second region and the corrosion and erosion resistance is thus much better than in the first region. The first region may be an edge region of the precious-metal section and the second region a center region of the precious-metal section.

In accordance with the present invention, a continuously operated diode laser (continuous wave laser) may be used, which produces a connection between electrode and precious-metal section by heat-conduction welding.

### BRIEF DESCRIPTION OF THE DRAWINGS

FIG. 1 shows a portion of an example embodiment of a spark plug, which portion is on the side of the combustion chamber, produced in accordance with the method of the present invention.

FIG. 2 shows a portion of an example embodiment of a spark plug, which portion is on the side of the combustion chamber, produced in accordance with the method of the present invention.

FIG. 3a shows an example embodiment of a ground electrode produced in accordance with the method of the present invention.

FIG. 3b shows an example embodiment of a ground electrode produced in accordance with the method of the present invention.

FIG. 3c shows an example embodiment of a ground electrode produced in accordance with the method of the present invention.

FIG. 4 shows an example embodiment of a ground electrode produced in accordance with the method of the present invention.

FIG. 5 shows an example embodiment of a center electrode produced in accordance with the method of the present invention.

FIG. 6 shows an interaction of a laser system with an electrode/precious-metal combination in accordance with the present invention.

FIG. 7 shows an interaction of a laser system with an electrode/precious-metal combination in accordance with the present invention.

FIG. 8 illustrates the intensity of the laser beam as a function of the location on the electrode along x-axis, in accordance with the present invention.

FIG. 9 shows a section through the ground electrode taken along line IX-IX shown in FIG. 8, perpendicular to the longitudinal axis of the ground electrode, and a chart illustrating the intensity of the laser beam as a function of location on the electrode along y-axis, in accordance with the present invention.

### DETAILED DESCRIPTION

FIGS. 1 through 5 show different example embodiments of spark plugs that are produced according to the method of the present invention. Elements that correspond to one another are denoted by matching reference numerals in the following.

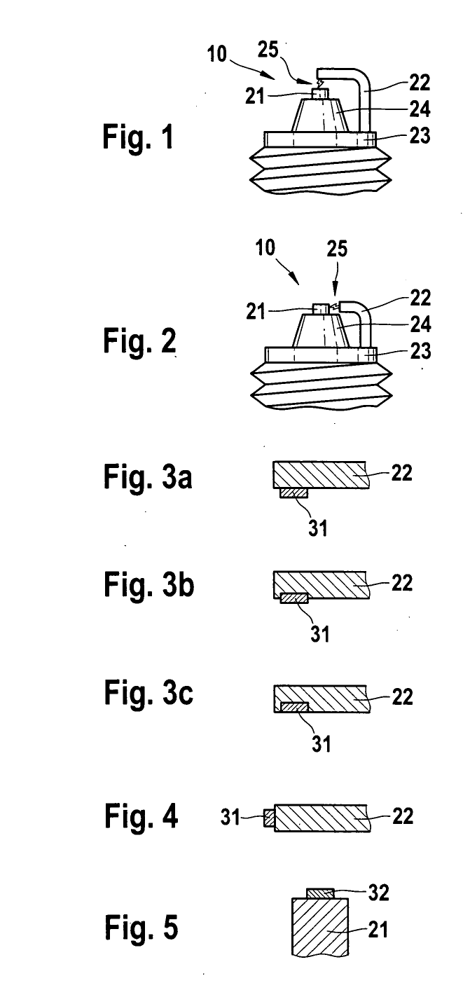

The basic design and the operation of a spark plug are well known in the related art, e.g., as disclosed in “Bosch-Technische Unterrichtung—Zündkerzen” (“Bosch Technical Information—Spark Plugs”), Robert Bosch GmbH, 1985, and detailed discussion regarding these topics need not be included here. In FIG. 1 and FIG. 2, the end, on the combustion-chamber side, of a spark plug 10 is schematically shown in a side view. Spark plug 10 has a tubular metal housing 23, which is essentially in radial symmetry. Disposed in a central bore along the axis of symmetry of metal housing 23 is a coaxially extending insulator 24. A center electrode 21 is located, on the combustion-chamber side, in a central bore extending along the longitudinal axis of insulator 24, and the center electrode 21 projects from the bore at the end, on the combustion-chamber side, of insulator 24. In another exemplary embodiment, which is not shown, center electrode 21 may also be arranged in such a way that it does not project from the bore of insulator 24.

At the end, away from the combustion chamber, of center electrode 21, an electrically conductive glass melt (not shown) is provided in the bore of insulator 24, which connects center electrode 21 to a connecting bolt (not shown), which is likewise disposed in the central bore of the insulator. At the end, on the combustion-chamber side, of the metal housing, one or a plurality of ground electrodes 22 are arranged as well. Beginning at housing 23, ground electrode 22 initially extends parallel to the axis of symmetry of housing 23, but the electrode 22 is subsequently bent at an approximately right angle to the axis of symmetry of housing 23. The electric energy reaching the end, on the combustion-chamber side, of spark plug 10 via the connecting bolt, the electrically conductive glass melt and center electrode 21, then causes a spark to arc over a spark gap 25 between center electrode 21 and ground electrode 22, the spark igniting the air-fuel mixture present in the combustion chamber. Various embodiments of ground electrode 22 are shown in greater detail in FIGS. 3a through 3c and in FIG. 4. FIG. 5 shows center electrode 21 in more detail.

The spark plug according to FIGS. 1 and 2 differ in the design of ground electrode 22. In the spark plug according to FIG. 1, ground electrode 22 is designed as so-called top electrode, which extends across the end face of center electrode 21. In a ground electrode 22 designed as top electrode, spark gap 25 is in the region of the axis of symmetry of housing 23 and insulator 24, and the spark gap 25 extends between the end face of center electrode 21 and the end section of ground electrode 22. In the spark plug according to FIG. 2, ground electrode 22 does not extend to the axis of symmetry of housing 23. The end section of ground electrode 22 facing center electrode 21 is disposed to the side of center electrode 21 and points to the radial surface area of center electrode 21. Ground electrode 22 thus does not project, or projects only slightly, beyond the end face of center electrode 21. As a result, the spark gap forms between the radial surface area of center electrode 21 and the end face of ground electrode 22.

Various example embodiments of the ends, on the combustion-chamber side, of ground electrode 22 are shown in cross-section in FIGS. 3a through 3c and FIG. 4. These example embodiments of the ground electrode shown in FIGS. 3a through 3c are suitable, for example, for the spark plug shown in FIG. 1, and the example embodiment of the ground electrode shown in FIG. 4 is suitable, for example, for the spark plug shown in FIG. 2.

At its end section, ground electrode 22 has a precious-metal section 31. Precious-metal section 31 is distinguished by high resistance with respect to spark erosion and corrosion, which ensures a long service life of the spark plug. Precious-metal section 31 forms one end of spark gap 25, so that the spark arcs over directly in the region of precious-metal section 31 of ground electrode 22.

The different example embodiments shown in FIGS. 3a through 3c differ in the arrangement of precious-metal section 31 of ground electrode 22. In FIG. 3a, precious-metal section 31 is provided externally on ground electrode 22, while in FIG. 3c precious-metal section 31 is disposed in a recess of ground electrode 22 and does not project beyond the surface area of ground electrode 22. In FIG. 3b, precious-metal section 31 is arranged in a recess of ground electrode 22, as in FIG. 3c, but projects beyond the outer surface of ground electrode 22 (as in FIG. 3a).

In FIG. 4, precious-metal section 31 is provided on the end face of ground electrode 22. The center electrode shown in FIG. 5 also has precious-metal section 31 at its end face. The example embodiments of FIGS. 3b and 3c, in which a recess in ground electrode 22 is provided for at least partially accommodating precious-metal section 31, may also be applied to the example embodiments shown in FIGS. 4 and 5.

Center electrode 21 and ground electrode 22 may be essentially made of nickel or a nickel alloy, and in most cases include a copper core, which ensures good thermal conduction. Precious-metal section 31 may be essentially made up of platinum. Apart from platinum, other metals such as iridium, rhodium, ruthenium or palladium, as well as alloys of two or more of these metals, are suitable as components of precious-metal section 31.

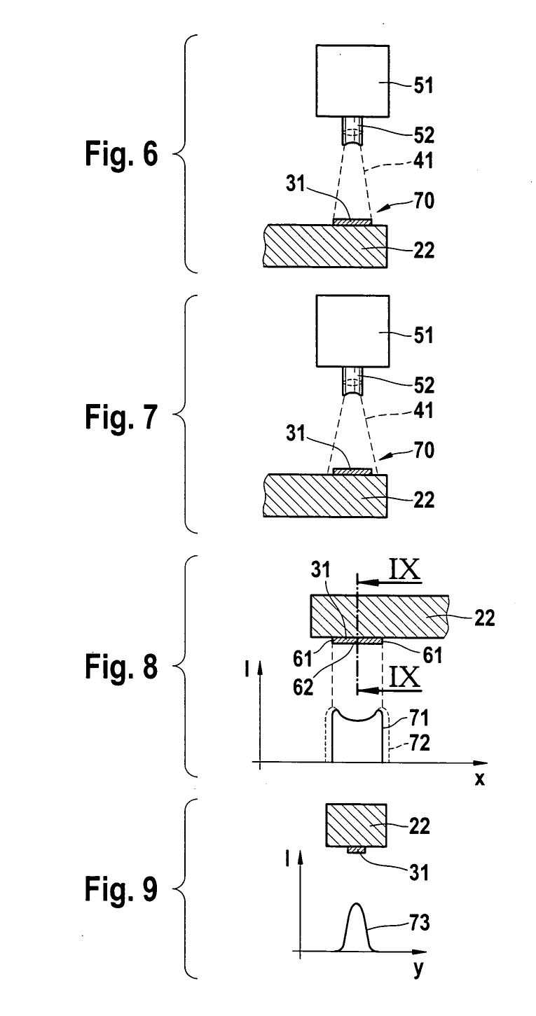

FIG. 6 shows a device for implementing the method of the present invention. By means of a laser 51 and an optical system 52, a laser beam 41 is guided to precious-metal section 31 of electrode 22. Laser 51, such as a diode laser, is operated continuously, i.e., in continuous wave mode. In the region of a laser spot 70, laser beam 41 impinges upon precious-metal section 31, thereby introducing heat into the precious-metal section, which results in a fusing of precious-metal section 31 and a region of ground electrode 22. This fusing process is called heat-conduction welding and produces a very reliable joining of precious-metal section 31 and ground electrode 22.

By optical system 52, laser beam 41 is shaped such that laser spot 70 covers the entire precious-metal section 31, so that every region of precious-metal section 31 is acted upon by laser beam 41. Laser 51 and laser beam 41 are spatially fixed with respect to ground electrode 22, i.e., there is no relative movement with respect to one another.

The device for implementing the method according to the present invention as shown in FIG. 7 differs from FIG. 6 merely in that laser spot 70 is wider than precious-metal section 31 and also impinges upon the regions of ground electrode 22 that are to the side of precious-metal section 31.

Suitable laser for the arrangements shown in FIGS. 6 and 7 is a semiconductor laser by which a compact beam source and high efficiency are able to be realized (typical performance quantity: J=5×10⁴ W/cm², λ=808/940 nm).

FIG. 8 shows the profile of intensity I of laser beam 41 along an x-direction, namely along the surface area of ground electrode 22 and precious-metal section 31, in the sectional plane (the sectional plane is defined by the longitudinal axis of the end section of ground electrode 22 and the longitudinal axis of spark plug 10, that is, the axis of symmetry of the housing). Optical system 52 shapes laser beam 41 in such a way that the intensity of laser beam 41 in an edge region 61 of precious-metal section 31 is greater than the intensity in a center region 62 of precious-metal section 31. First intensity curve 71 corresponds to the shape of laser beam 41 according to FIG. 6; second intensity curve 72, shown as a dashed line, corresponds to the shape of laser beam 41 according to FIG. 7. Second intensity curve 72 matches first intensity curve 71 in center region 62 of precious-metal section 31.

The intensity of laser beam 41 may also have a constant profile or some other profile, for example in applications in which the corrosion resistance plays a less important role.

FIG. 9 shows the intensity profile of laser beam 41 in the case that the precious-metal section 31 has an elongated shape, as in the example embodiment shown in FIG. 8 (FIG. 9 also shows a sectional view of electrode 22 and precious-metal section 31 taken along line IX-IX in FIG. 8), and the precious-metal section is applied onto ground electrode 22 by fusing a wire. The wire has a length of 2 mm, for instance, and a diameter of 0.3 to 0.6 mm. In accordance with the geometry of precious-metal section 31, the laser beam has a linear focus. Such a precious-metal section 31 may be used, for instance, in the example embodiments according to FIGS. 3a through 3c. In FIG. 9, an intensity curve 73 shows the profile of intensity I of laser beam 41 along a y-direction, i.e., along the surface width of ground electrode 22 and precious-metal section 31, in the sectional plane (the sectional plane runs perpendicularly to the longitudinal axis of the end section of ground electrode 22). In accordance with the form of precious-metal section 31, laser beam 41 has a wider with in the x-direction than in the y-direction.

The shape of precious-metal section 31 may be selected as desired. It should be ensured that laser spot 70 covers precious-metal section 31 at least nearly in its entirety, so that no relative movement between laser beam 41 and precious-metal section 31 is required to join precious-metal section 31 to electrode 22 (or 21 in the embodiment shown in FIG. 5).

The intensity of the laser beam may be so low in regions of the precious-metal section that the heat, which is input into these regions of the precious-metal section by the laser beam, is not sufficient to fuse the precious metal to the electrode. Such a region may be, for example, the center region of the precious-metal section, as described in connection with FIG. 8. It is essential in this case that the laser beam is spatially fixed with respect to the precious-metal section and the electrode during the joining procedure.

Although the present invention has been described in the context of spark plugs that have an electrode at whose end section a precious-metal section is provided, the present invention is not restricted to the exemplary embodiments described in the specification.

What is claimed is:

1. A method for joining a precious-metal section to an electrode of a spark plug, comprising:
positioning the precious-metal section on the electrode; and
applying a laser beam at least to the precious-metal section positioned on the electrode, wherein the precious-metal section is joined to the electrode by heat input generated by the laser beam, and wherein the laser beam at least substantially covers the precious-metal section.

2. The method as recited in claim 1, wherein no relative movement occurs between the laser beam and the precious-metal section during the application of the laser beam.

3. The method as recited in claim 2, wherein an intensity of a first portion of the laser beam applied to a first region of the precious-metal section is higher than an intensity of a second portion of the laser beam applied to a second region of the precious-metal section.

4. The method as recited in claim 3, wherein at least the first region of the precious-metal section is fused with the electrode to form an alloy.

5. The method as recited in claim 4, wherein, following the application of the laser beam on the precious-metal section, the alloy contains a higher proportion of the material of the electrode in an area of the alloy corresponding to the first region of the precious-metal section than in an area of the alloy corresponding to the second region of the precious-metal section.

6. The method as recited in claim 3, wherein the precious-metal section has an edge region and a center region, and wherein the intensity of the first portion of the laser beam applied to the edge region of the precious-metal section is greater than the intensity of the second portion of the laser beam applied to the center region of the precious-metal region.

7. The method as recited in claim 6, wherein the electrode contains nickel, and wherein the precious-metal section contains at least one of platinum, iridium, rhodium, ruthenium and palladium.

8. The method as recited in claim 3, wherein the precious-metal section is positioned at least partially in a recess provided in the electrode.

9. The method as recited in claim 8, wherein the spark plug includes a center electrode and at least one ground electrode, the ground electrode being joined to the precious-metal section, the center electrode being electrically insulated from a housing of the spark plug by an insulator, and the ground electrode being affixed to the housing.

10. The method as recited in claim 8, wherein the spark plug includes a center electrode and at least one ground electrode, the center electrode being joined to the precious-metal section, the center electrode being electrically insulated from a housing of the spark plug by an insulator, and the ground electrode being affixed to the housing.

11. The method as recited in claim 3, wherein the laser beam is applied continuously.

12. The method as recited in claim 3, wherein the precious-metal section contains at least one of a pure precious metal, a precious-metal alloy and an alloy containing a precious metal.

13. The method as recited in claim 3, wherein the laser beam achieves joining of the electrode and the precious-metal section by heat-conduction welding.

14. A spark plug, comprising:
an electrode; and
a precious-metal section joined to the electrode and having improved corrosion resistance, the precious-metal section containing an alloy that includes at least one precious metal and a material of the electrode, wherein the proportion of the material of the electrode varies in the precious-metal section.

15. The spark plug as recited in claim 14, wherein the precious-metal section has an edge region and a center region, and wherein the edge region contains a higher proportion of the material of the electrode than the center region.
